(19) United States
(12) Patent Application Publication
(10) Pub. No.: US 2026/0179851 A1
(43) Pub. Date: Jun. 25, 2026

(54) MULTILAYER ELECTRONIC COMPONENT

(71) Applicant: SAMSUNG ELECTRO-MECHANICS CO., LTD., Suwon-si (KR)

(72) Inventors: Sun Kyoung Park, Suwon-si (KR); Chae Dong Lee, Suwon-si (KR)

(73) Assignee: SAMSUNG ELECTRO-MECHANICS CO., LTD., Suwon-si (KR)

(21) Appl. No.: 19/347,264

(22) Filed: Oct. 1, 2025

(30) Foreign Application Priority Data
Dec. 24, 2024 (KR) 10-2024-0194884

(51) Int. Cl. H01G 4/248; H01G 4/232; H01G 4/30

(52) U.S. Cl. CPC H01G 4/248; H01G 4/232; H01G 4/30

(57) ABSTRACT

A multilayer electronic component includes a dielectric layer and first and second internal electrodes, a body including first and second surfaces opposing each other, third and fourth surfaces opposing each other, and fifth and sixth surfaces opposing each other, a glass layer disposed on the fifth and/or sixth surfaces, a first external electrode disposed on the glass layer, and second and third external electrodes disposed on the third and fourth surfaces, respectively, wherein the first internal electrode has a connection terminal extended to the fifth or sixth surface, and the glass layer is disposed to cover a portion of the connection terminal, and a length of the connection end is L1, and a length of a region of the connection terminal in contact with the first external electrode is L2, L1 and L2 may satisfy 0.74≤L2/L1≤0.90.

### CROSS-REFERENCE TO RELATED APPLICATION(S)

This application claims benefit of priority to Korean Patent Application No. 10-2024-0194884 filed on Dec. 24, 2024 in the Korean Intellectual Property Office, the disclosure of which is incorporated herein by reference in its entirety.

### TECHNICAL FIELD

The present disclosure relates to a multilayer electronic component.

### BACKGROUND ART

A multilayer ceramic capacitor (MLCC), a multilayer electronic component, is a chip-type condenser, mounted on the printed circuit boards of various types of electronic product, such as image display devices including a liquid crystal display LCD and a plasma display panel PDP, computers, smartphones and mobile phones, and serves to charge or discharge electricity therein or therefrom. Such multilayer ceramic capacitors may be used as a component in various electronic devices due to having a small size, ensuring high capacitance and being easily mounted.

Currently, not only two-terminal MLCCs having two external electrodes, but three-terminal or four-terminal MLCCs with changed structures of internal and external electrodes are also being developed to improve frequency characteristics.

In particular, the three-terminal MLCC may have a structure in which ground internal electrodes and signal internal electrodes having a lead portion may be alternately stacked. In the case of three-terminal MLCC, the external electrode should be precisely applied to a portion where the lead portion is exposed and when the external electrode is not precisely applied and the lead portion is exposed to the outside, there may be a concern that external moisture may penetrate into the inside of the MLCC through the exposed area. Additionally, when there is a thickness deviation of the ground internal electrode or the external electrode, there is a concern that external moisture may penetrate into the inside of the MLCC through a thin portion of the ground internal electrode and/or the external electrode.

Since the external moisture penetrating into the MLCC may deteriorate the reliability of the MLCC, such as by lowering insulation resistance of the MLCC, research on structures of internal and external electrodes that may prevent the external moisture penetration is needed.

### DISCLOSURE OF INVENTION

### Technical Problem

An aspect of the present disclosure is to provide a multilayer electronic component having excellent reliability.

However, problems to be solved by the present disclosure are not limited to the above, and will be more easily understood in the process of describing specific embodiments of the present disclosure.

### Solution to Problem

A multilayer electronic component according to an embodiment of the present disclosure may comprise: a body including a dielectric layer and first and second internal electrodes alternately disposed in a first direction with the dielectric layer interposed therebetween, first and second surfaces opposing each other in the first direction, third and fourth surfaces connected to the first and second surfaces and opposing each other in a second direction, and fifth and sixth surfaces connected to the first to fourth surfaces and opposing each other in a third direction, a glass layer disposed on at least one surface among the fifth and sixth surfaces, a first external electrode disposed on the glass layer and connected to the first internal electrode, and second and third external electrodes disposed on the third and fourth surfaces, respectively, and connected to the second internal electrode, wherein the first internal electrode has a connection terminal extended to the fifth or sixth surface, and the glass layer is disposed to cover a portion of the connection terminal, where a length of the connection terminal in the second direction is L1, and a length of a region of the connection terminal in contact with the first external electrode in the second direction is L2, L1 and L2 may satisfy 0.74≤L2/L1≤0.90.

### Advantageous Effects of Invention

According to an aspect of the present disclosure, multilayer electronic component with excellent reliability may be provided.

### BRIEF DESCRIPTION OF DRAWINGS

FIG. 1 is a perspective view schematically illustrating a multilayer electronic component according to an embodiment of the present disclosure.

FIG. 2 is a perspective view of FIG. 1 with a first external electrode removed.

FIG. 3 schematically illustrates a cross-sectional view taken along line I-I′ of FIG. 1.

FIG. 4 schematically illustrates a cross-sectional view taken along line II-II′ of FIG. 1.

FIG. 5a schematically illustrates a cross-sectional view taken along line III-III′ of FIG. 1, illustrating a planar structure of a first internal electrode.

FIG. 5b schematically illustrates a cross-sectional view taken along line III-III′ of FIG. 1, illustrating a planar structure of a second internal electrode.

FIG. 6 is an enlarged view schematically illustrating region K of FIG. 5a.

FIG. 7 is a modified example of FIG. 6.

### DESCRIPTION OF REFERENCE CHARACTERS

Hereinafter, embodiments of the present disclosure will be described with reference to specific embodiments and the accompanying drawings. However, embodiments of the present disclosure may be modified into various other forms, and the scope of the present disclosure is not limited to the embodiments described below. Further, embodiments of the present disclosure may be provided for a more complete description of the present disclosure to the ordinary artisan. Therefore, shapes and sizes of the elements in the drawings may be exaggerated for clarity of description, and the elements denoted by the same reference numerals in the drawings may be the same elements.

In the drawings, portions not related to the description will be omitted for clarification of the present disclosure, and a thickness may be enlarged to clearly illustrate layers and regions. The same reference numerals will be used to designate the same components with the same reference numerals. Further, throughout the specification, when an element is referred to as “comprising” or “including” an element, it means that the element may further include other elements as well, without departing from the other elements, unless specifically stated otherwise.

In the drawings, a first direction X may be defined as a thickness T direction, a second direction Y may be defined as a length L direction, and a third direction Z may be defined as a width W direction.

### Multilayer Electronic Component

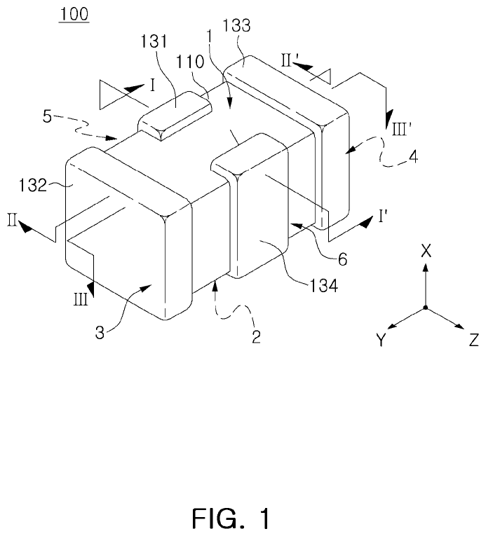

FIG. 1 is a perspective view schematically illustrating a multilayer electronic component according to an embodiment of the present disclosure.

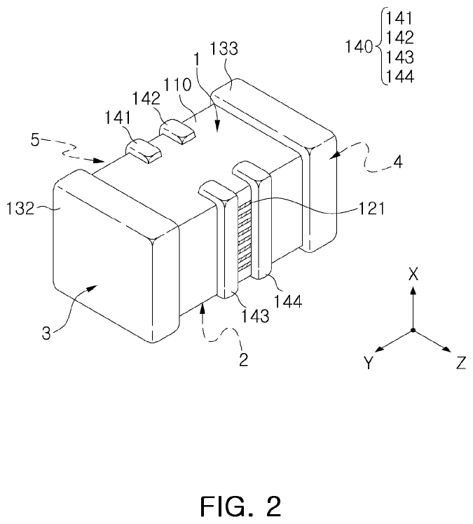

FIG. 2 is a perspective view of FIG. 1 with a first external electrode removed.

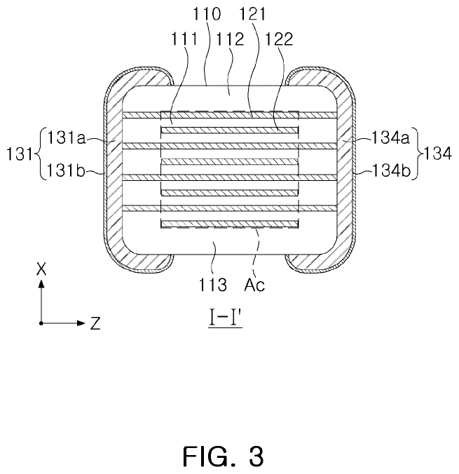

FIG. 3 schematically illustrates a cross-sectional view taken along line I-I′ of FIG. 1.

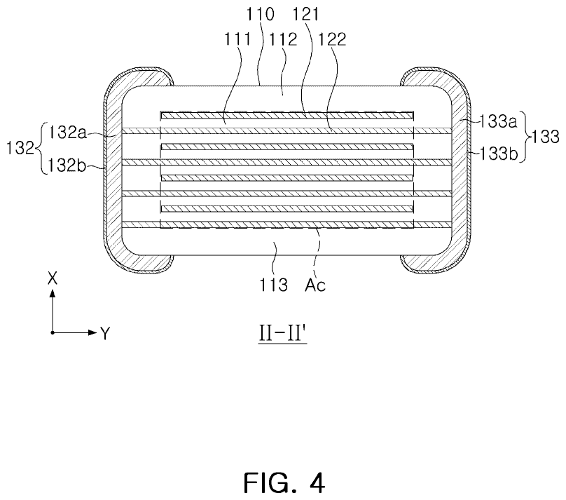

FIG. 4 schematically illustrates a cross-sectional view taken along line II-II′ of FIG. 1.

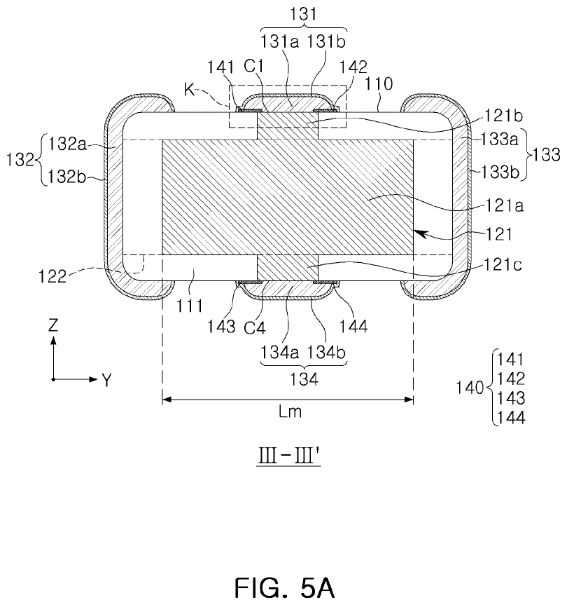

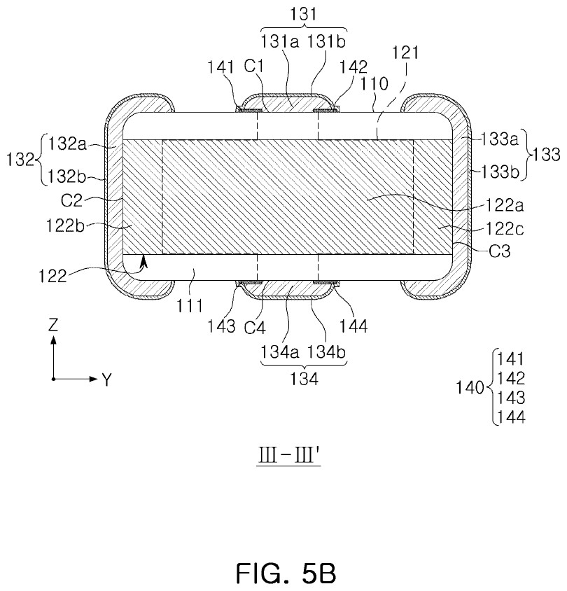

FIG. 5A schematically illustrates a cross-sectional view taken along line III-III′ of FIG. 1, illustrating a planar structure of a first internal electrode.

FIG. 5B schematically illustrates a cross-sectional view taken along line III-III′ of FIG. 1, illustrating a planar structure of a second internal electrode.

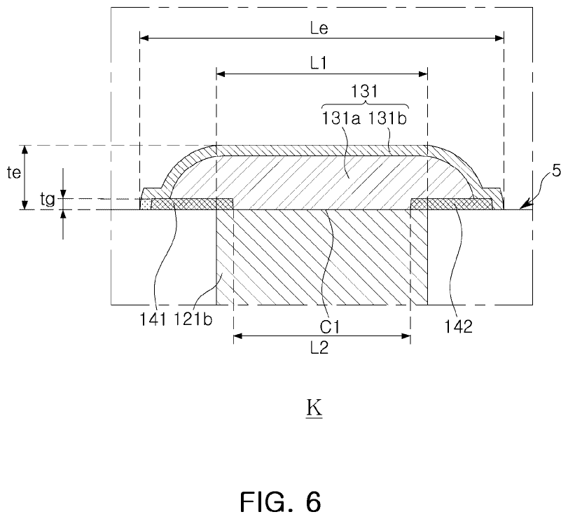

FIG. 6 is an enlarged view schematically illustrating a region K of FIG. 5A.

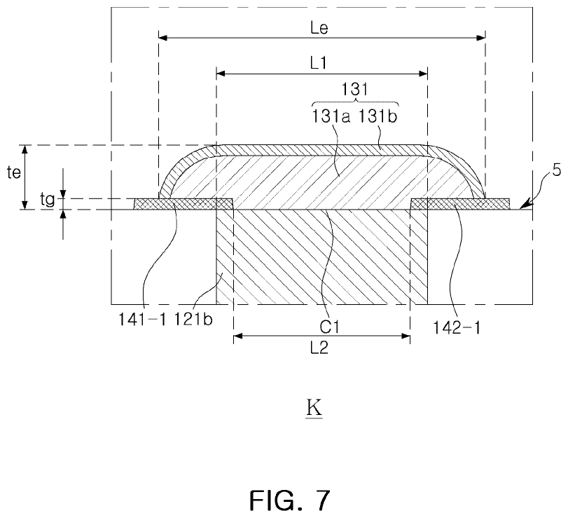

FIG. 7 is a modified example of FIG. 6.

Hereinafter, a multilayer electronic component 100 according to an embodiment of the present disclosure will be described in detail with reference to FIGS. 1 to 7. In addition, as an example of a multilayer electronic component, a multilayer ceramic capacitor is described, but the present disclosure is not limited thereto and may also be applied to various multilayer electronic components, such as inductors, piezoelectric elements, varistors, or thermistors.

The multilayer electronic component 100 according to an embodiment of the present disclosure may include a body 110 including a dielectric layer 111 and internal electrodes 121 and 122, external electrodes 131, 132, 133, and 134, and a glass layer 140.

There is no particular limitation on the specific shape of the body 110, but as illustrated, the body 110 may have a hexahedral shape or a shape similar thereto. Due to shrinkage of ceramic powder particles included in the body 110 during a sintering process or due to the polishing process for the corner portions of the body 110, the body 110 may not have a hexahedral shape with entirely straight lines, but may have a substantially hexahedral shape.

The body 110 may have first and second surfaces 1 and 2 opposing each other in the first direction, third and fourth surfaces 3 and 4 connected to the first and second surfaces 1 and 2 and opposing each other in the second direction, and fifth and sixth surfaces 5 and 6 connected to the first to fourth surfaces 1, 2, 3, and 4 and opposing each other in the third direction.

A plurality of dielectric layers 111 forming a body 110 are in a sintered state, such that boundaries between adjacent dielectric layers 111 may be integrated so as to be difficult to identify without using a scanning electron microscope (SEM).

The dielectric layer 111 may include, for example, a perovskite-type compound represented by ABO₃ as a main component. The perovskite-type compound represented by ABO₃ may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃ and (Ca₁₋ₓSrₓ)(Zr_{1-y}Ti_{y})O₃ (0<x≤0.5, 0<y≤0.5).

An average thickness of the dielectric layer 111 is not particularly limited. The average thickness of the dielectric layer 111 may be, for example, 0.1 μm to 20 μm, 0.1 μm to 10 μm, 0.1 μm to 5 μm, 0.1 μm to 2 μm, or 0.1 μm to 0.4 μm.

The body 110 may include a first internal electrode 121 and a second internal electrode 122 that are alternately disposed in the first direction with the dielectric layer 111 interposed therebetween. The first internal electrode 121 and the second internal electrode 122, a pair of electrodes having different polarities, may be disposed opposing each other with the dielectric layer 111 therebetween.

Referring to FIG. 5A, the first internal electrode 121 may have a first connection terminal C1 and C4 extended to the fifth or sixth surface 5 and/or 6. The first internal electrode 121 may include, for example, a first main portion 121a overlapping the second internal electrode 122 in the first direction, and first lead portions 121b and 121c extending from the first main portion 121a to the fifth or sixth surface 5 or 6, not overlapping the second internal electrode 122 in the first direction, and having first connection terminals C1 and C4. That is, one end portion of the first lead portions 121b and 121c in the third direction may be defined as the first connection terminal C1 and C4.

The first internal electrode 121 may be spaced apart from the third and fourth surfaces 3 and 4, and may be connected to the first external electrodes 131 and 134, for example, through a pair of first lead portions 121b and 121c exposed to the fifth and sixth surfaces 5 and 6, respectively. However, the present disclosure is not limited thereto, and the first internal electrode 121 may be exposed to only one of the fifth and sixth surfaces 5 and 6, and in this case, the first internal electrode 121 may have one first lead portion.

The shape of the first main portion 121a is not particularly limited, but may have, for example, a flat plate shape perpendicular to the first direction. In an embodiment, a maximum length Lm of the first main portion 121a in the second direction may be greater than a length L1 of the first connection terminal C1 and C4 in the second direction.

Although FIG. 5A illustrates a structure in which the lengths of the first lead portions 121b and 121c in the second direction are constant, the present disclosure is not limited thereto. For example, the first lead portions 121b and 121c may have a form in which the lengths in the second direction decreases from the first main portion 121a toward the first external electrodes 131 and 134, and the first lead portions 121b and 121c may have a form in which the lengths in the second direction increases from the first main portion 121a toward the first external electrodes 131 and 134.

Referring to FIG. 5B, the second internal electrode 122 may have a second and third connection terminal C2 and C3 extended to the third and fourth surface 3 and 4. The second internal electrode 122 may include, for example, a second main portion 122a overlapping the first internal electrode 121 in the first direction and extending respectively from the second main portion 122a toward the third and fourth surfaces 3 and 4, and the second and third lead portions 122b and 122c not overlapping the first internal electrode 121 in the first direction. The second and third lead portions 122b and 122c may have second and third connection terminals C2 and C3, respectively. That is, one end portion of the second and third lead portions 122b and 122c in the second direction may be defined as second and third connection terminal C2 and C3.

The second internal electrode 122 may be connected for example, to the second and third external electrodes 132 and 133 through second and third lead portions 122b and 122c, which are exposed to the third and fourth surfaces 3 and 4, respectively. The second internal electrode 122 may be spaced apart from the fifth and sixth surfaces 5 and 6, but the present disclosure is not limited thereto, and the second and third lead portions 122b and 122c may be extended to the fifth and sixth surfaces 5 and 6, respectively. In this case, the second lead portion 122b may be connected to the second external electrode 132 on the third, fifth, and sixth surfaces 3, 5, and 6, and the third lead portion 122c may be connected to the third external electrode 133 on the fourth, fifth, and sixth surfaces 4, 5, and 6.

Although FIG. 5B illustrates a structure in which a length of the second and third lead portions 122b and 122c in the third direction is constant, the present disclosure is not limited thereto. For example, the second and third lead portions 122b and 122c may each have a form in which a length in the third direction decreases from the second main portion 122a toward the second and third external electrodes 132 and 133, respectively, and the second and third lead portions 122b and 122c may have a form in which a length in the third direction increases from the second main portion 122a toward the second and third external electrodes 132 and 133, respectively. In the present disclosure, having a form in which the length decreases or increases in the second or third direction may mean that, although the length remains constant in certain sections among the entire section from one point to another, overall tendency of the length is to decrease or increase.

A metal included in the internal electrodes 121 and 122 may be one or more selected from the group consisting of Ni, Cu, Pd, Ag, Au, Pt, Sn, W, Ti, and alloys thereof, and more preferably, the internal electrodes 121 and 122 may include Ni, but the present disclosure is not limited thereto.

An average thickness of the internal electrodes 121 and 122 is not particularly limited. The average thicknesses of the internal electrodes 121 and 122 may be, for example, 0.1 μm to 3.0 μm, 0.1 μm to 1.0 μm, or 0.1 μm to 0.4 μm.

The average thickness of the dielectric layer 111 and the average thickness of the internal electrodes 121 and 122 respectively refers to average thicknesses of the dielectric layer 111 and the internal electrodes 121 and 122 in the first direction. The average thickness of the dielectric layer 111 and the average thickness of the internal electrodes 121 and 122 may be measured by scanning a cross section of the body 110 in the first and second direction with a scanning electron microscope SEM of 10,000× magnification. More specifically, the average thickness of the dielectric layer 111 may be measured by calculating the average after measuring the thickness at a plurality of points of one dielectric layer 111, for example, at 5 points equally spaced apart from each other in the second direction, and then taking the average value. In addition, the average thicknesses of the internal electrodes 121 and 122 may be measured by calculating the average after measuring the thicknesses at a plurality of points of one internal electrodes 121 and 122, for example, at 5 points equally spaced apart from each other in the second direction. The 5 points equally spaced apart from each other may be designated in a capacitance formation portion Ac. When the average value measurements are performed for each of 10 dielectric layers 111 and 10 internal electrodes 121 and 122, and then the average values may be calculated, the average thickness of the dielectric layer 111 and the average thicknesses of the internal electrodes 121 and 122 may be further generalized.

The body 110 may include a capacitance formation portion Ac, in which capacitance is formed by first and second internal electrodes 121 and 122 alternately disposed with a dielectric layer 111 interposed therebetween, and cover portions 112 and 113 disposed on opposite surfaces of the capacitance formation portion AC in the first direction. The cover portions 112 and 113 may have a similar configuration to the dielectric layer 111 except for not including the internal electrode.

An average thickness of the cover portions 112 and 113 may not be particularly limited. The average thickness of the cover portions 112 and 113 may be, for example, 200 μm or less, 150 μm or less, 100 μm or less, 30 μm or less or 20 μm or less. The average thicknesses of the cover portions 112 and 113 may be, for example, 5 μm or more, 10 μm or more, or 30 μm or more. In this case, the average thicknesses of the cover portions 112 and 113 may refer to an average thickness of each of the first cover portion 112 and the second cover portion 113.

The average thickness of the cover portions 112 and 113 may refer to an average thickness of the cover portions 112 and 113 in the first direction, and may be an average value of thicknesses in the first direction measured at 5 points equally spaced apart from each other in a cross-section of the body 110 in the first and second directions.

The first external electrodes 131 and 134 may be disposed on the glass layer 140 and may be connected to the first internal electrode 121. For example, a pair of the first external electrodes 131 and 134 may be disposed on the fifth and sixth surfaces 5 and 6, respectively, and may be connected to the first lead portions 121b and 121c. A pair of first external electrodes 131 and 134 may be disposed to extend onto portions of the first and second surfaces 1 and 2. However, the present disclosure is not limited thereto, and the first external electrodes 131 and 134 may be disposed on only one of the fifth and sixth surfaces 5 and 6. In addition, the first external electrode 131 disposed on the fifth surface 5 and the first external electrode 134 disposed on the sixth surface 6 may be connected to each other on the first and/or second surfaces 1 and/or 2.

The second external electrode 132 and the third external electrode 133 may be disposed on the third and fourth surfaces 3 and 4, respectively and may be connected to the second internal electrode 122. The second external electrode 132 may be connected to the second lead portion 122b on the third surface 3, and the third external electrode 133 may be connected to the third lead portion 122c on the fourth surface 4. The second external electrode 132 may be disposed to extend from the third surface 3 onto portions of the first, second, fifth, and sixth surfaces 1, 2, 5, and 6, and the third external electrode 133 may be disposed to extend from the fourth surface 4 onto portions of the first, second, fifth, and sixth surfaces 1, 2, 5, and 6.

Types or shapes of the external electrodes 131 and 132 may not be particularly limited, and may have a multilayer structure. For example, the external electrodes 131, 132, 133, and 134 may include base electrode layers 131a, 132a, 133a, and 134a in contact with the connection terminals C1, C2, C3, and C4, and plating layers 131b, 132b, 133b, and 134b disposed on the base electrode layers 131a, 132a, 133a, and 134a, respectively. That is, the first external electrodes 131 and 134 may include first base electrode layers 131a and 134a in contact with the first connection terminals C1 and C4, and first plating layers 131b and 134b disposed on the first base electrode layers 131a and 134a, respectively. The second external electrode 132 may include a second base electrode layer 132a in contact with the second connection terminal C2, and a second plating layer 132b disposed on the second base electrode layer 132a. The third external electrode 133 may include a third base electrode layer 133a in contact with the third connection terminal C3, and a third plating layer 133b disposed on the third base electrode layer 133a.

The base electrode layers 131a, 132a, 133a, and 134a may be sintered electrode layers including metal and glass. The metal included in the base electrode layers 131a, 132a, 133a, and 134a may include, for example, at least one selected from the group consisting of Cu, Ni, Pd, Pt, Au, Ag, Pb, and alloys thereof.

The base electrode layers 131a, 132a, 133a, and 134a may be configured by only the sintered electrode layer, but the present disclosure is not limited thereto, and the base electrode layers 131a, 132a, 133a, and 134a may have a multilayer structure. For example, the base electrode layers 131a, 132a, 133a, and 134a may include a sintered electrode layer and a resin electrode layer disposed on the sintered electrode layer and including metal particles and resin.

The metal particles included in the resin electrode layer may include one or more of spherical particles and flake-shaped particles. The metal particles included in the resin electrode layer may include, for example, Cu, Ni, Pd, Pt, Au, Ag, Pb, Sn and/or alloys thereof. The resin included in the resin electrode layer may include, for example, one or more of epoxy resin, acrylic resin, and ethyl cellulose.

The plating layers 131b, 132b, 133b, and 134b may include, for example, Ni, Sn, Pd and/or alloys thereof, and may be formed of a plurality of layers. The plating layers 131b, 132b, 133b, and 134b may be, for example, Ni plating layer or Sn plating layer, and may also be in the form in which the Ni plating layer and the Sn plating layer are formed sequentially thereon. Additionally, the plating layers 131b, 132b, 133b, and 134b may include a plurality of Ni plating layers and/or a plurality of Sn plating layers.

Although the drawing describes a structure in which a multilayer electronic component 100 has four external electrodes 131, 132, 133, and 134, it may not be limited thereto, and the number or shape of the external electrodes 131, 132, 133, and 134 may be changed depending on the shape of the internal electrodes 121 and 122 or other purposes.

Referring to FIGS. 5A and 6, the glass layer 140 may be disposed on at least one of the fifth and sixth surfaces 5 and 6. The glass layer 140 may be, for example, disposed on the fifth and sixth surfaces 5 and 6, respectively. The glass layer 140 may be disposed to cover a portion of the first connection terminals C1 and C4.

When the first external electrodes 131 and 134 are not accurately applied onto the first connection terminals C1 and C4, the first connection terminals C1 and C4 may be exposed to the outside. In this case, external moisture may easily penetrate inside the multilayer electronic component 100 through the first connection terminals C1 and C4 exposed to the outside. Additionally, due to process limitations, the first connection terminals C1 and C4 may have thin portions, or the first external electrodes 131 and 134 may have thin portions, and the external moisture may penetrate into the multilayer electronic component 100 through the corresponding portions.

On the other hand, according to an embodiment of the present disclosure, the length L1 of the first connection terminals C1 and C4 in the second direction, and the length L2 of a region of the first connection terminals C1 and C4 in contact with the first external electrodes 131 and 134 in the second direction may satisfy 0.74≤L2/L1≤0.90, it may prevent excessive increase in ESR while improving the moisture resistance reliability of the multilayer electronic component 100. In this case, the region of the first connection terminals C1 and C4 in contact with the first external electrodes 131 and 134 may refer to a region of the first connection terminals C1 and C4 that is not covered by the glass layer 140.

When L2/L1 exceeds 0.9, the glass layer 140 may not sufficiently cover the first connection terminals C1 and C4, which may cause a decrease in the moisture resistance reliability of the multilayer electronic component 100. When L2/L1 is less than 0.74, the glass layer 140 may excessively cover the first connection terminals C1 and C4, which may cause a decrease in connectivity between the first internal electrode 121 and the first external electrodes 131 and 134. In this case, there is a concern that the ESR of the multilayer electronic component 100 may be increase.

In an embodiment, the L1 and L2 may satisfy L2/L1≥0.81. In this case, the moisture resistance reliability and ESR of the multilayer electronic components 100 may be improved more effectively.

The L1 and L2 may be measured, for example, from images of cross-sections in the second and third directions, polished to a center portion of the multilayer electronic component 100 in the first direction, observed by an optical microscope OM or a scanning electron microscope (SEM).

The glass layer 140 may satisfy 0.74≤L2/L1≤0.90, and the arrangement form of the glass layer 140 is not particularly limited. However, the glass layer 140 may include the first glass layers 141 and 143 disposed to cover one end portion of the first connection terminals C1 and C4 in the second direction, and the second glass layers 142 and 144 spaced apart from the first glass layers 141 and 143, and disposed to cover the other end portion of the first connection terminals C1 and C4 in the second direction.

External moisture may easily penetrate inside the multilayer electronic component 100 through a boundary between the first connection terminals C1 and C4 and the dielectric layer 111. That is, the boundary between the first connection terminals C1 and C4 and the dielectric layer 111 may be a vulnerable portion to moisture penetration. In order to cover portions vulnerable to moisture penetration with the glass layer 140 while maintaining the connection between the first internal electrode 121 and the first external electrodes 131 and 134, the glass layer 140 may be disposed to cover both end portions of the first connection terminals C1 and C4 in the second direction, and may include first glass layers 141 and 143 and the second glass layers 142 and 144 spaced apart from each other.

Referring to FIG. 2, the first glass layers 141 and 143 may be disposed to extend, for example, from at least one surface of the fifth and sixth surfaces 5 and 6 onto a portion of the first and second surfaces 1 and 2, and the second glass layers 142 and 144 may be disposed to extend from at least one surface of the fifth and sixth surfaces 5 and 6 onto a portion of the first and second surfaces 1 and 2. A pair of first glass layers 141 and 143 may be disposed on the fifth and sixth surfaces 5 and 6, respectively, and may extend onto portions of the first and second surfaces 1 and 2, and a pair of second glass layers 142 and 144 may be disposed on the fifth and sixth surfaces 5 and 6, respectively, and may extend onto portions of the first and second surfaces 1 and 2.

The glass layer 140 may be spaced apart from the second and third external electrodes 132 and 133. The first glass layers 141 and 143 may be spaced apart from the second external electrode 132, and the second glass layers 142 and 144 may be spaced apart from the third external electrode 133. When the glass layer 140 is in contact with the second and third external electrodes 132 and 133, it may be a concern that when mounting the multilayer electronic component 100 on a printed circuit board, a contact between the second and third external electrodes 132 and 133 and the solder may be interrupted, thereby interrupting mounting stability.

In an embodiment, in the cross-sections of the multilayer electronic component 100 in the second and third direction, a length of a region of the glass layer 140 that is not in contact with the first connection terminals C1 and C4 may be greater than a length of a remaining region that is in contact with the first connection terminals C1 and C4. The external surface of the body 110 may be mainly formed of ceramic component, and bonding force between the ceramic and a glass may be greater than bonding force between a metal and the glass. When the length of the region of the glass layer 140 that is not in contact with the first connection terminals C1 and C4 is greater than the length of the remaining region in contact with the first connection terminals C1 and C4, the bonding force between the body 110 and the glass layer 140 may be improved, and as a result, the moisture resistance reliability of the multilayer electronic component 100 may be more effectively improved.

In an embodiment, the first external electrodes 131 and 134 may be disposed to completely cover the glass layer 140. The first external electrode 131 may be disposed to completely cover the first glass layer 141 and the second glass layer 142, and the first external electrode 134 may be disposed to completely cover the first glass layer 142 and the second glass layer 143.

For example, one end portion of the glass layer 140 in the second direction may be exposed from the first base electrode layers 131a and 134a, and the first plating layers 131b and 134b may be disposed to cover the end portion of the glass layer 140 in the second direction. That is, the end portion of the glass layer 140 in the second direction may be exposed from the first base electrode layers 131a and 134a and may be in contact with the first plating layers 131b and 134b, and the other end portion of the glass layer 140 in the second direction may be in contact with the first connection terminals C1 and C4.

However, the present disclosure is not limited thereto. Referring to FIG. 7, one end portion of glass layers 141-1 and 142-1 in the second direction may be exposed from the first plating layer 131b. That is, one end portion of the glass layers 141-1 and 142-1 in the second direction may be exposed outside the first external electrode 131, and the other end portion of the glass layers 141-1 and 142-1 in the second direction may be in contact with the first connection terminal C1.

Referring to FIGS. 6 and 7, in an embodiment, a maximum length Le of the first external electrode in the second direction may be greater than a length L1 of the connection terminal in the second direction. As a result, even if the first external electrode 131 is not precisely applied to a center portion of the first connection end C1, it may prevent the first connection terminal C1 from being exposed to the outside.

A thickness tg of the glass layer is not particularly limited, however in an embodiment, the thickness tg of the glass layer may be smaller than the thickness te of the first external electrode. When the tg is greater than te, a problem may occur in which a size of the multilayer electronic component may increases excessively. For example, tg may be 5 μm or more and 20 μm or less.

The glass layer 140 may include, for example, a first glass. The first glass may include one or more selected from the group consisting of Ba, Si, Zn, Ca, Al, and Mg. Meanwhile, the first external electrodes 131 and 134 may include first base electrode layers 131a and 134a being in contact with the first connection terminals C1 and C4 and containing a metal and a second glass. The second glass may include one or more selected from the group consisting of Ba, Si, Zn, Ca, Al, and Mg, but may have a different composition from the first glass.

In an embodiment, when a sum of number of moles of Ba and Si with respect to a total number of moles of the elements excluding oxygen among elements configuring the first glass is M1, and a sum of number of moles of Ba and Si with respect to a total number of moles of the elements excluding oxygen among elements configuring the second glass is M2, M1>M2 may be satisfied. When M1>M2 is satisfied, a softening temperature of the first glass may be higher than that of the second glass. As a result, when forming the first base electrode layers 131a and 134a after forming the glass layer 140, the first glass may be prevented from softening, thereby a shape of the glass layer 140 may be maintained.

The components of the first and second glasses may be calculated from images observed using SEM-EDS (Scanning Electron Microscope-Energy Dispersive X-ray Spectroscopy). Specifically, after exposing cross-sections in the second and third directions polished to a center portion of the multilayer electronic component 100 in the first direction, a center portion of the glass layer 140 may be analyzed for its components using ESD, and the M1 and M2 may be calculated based on the mol % of remaining elements excluding oxygen atoms.

Hereinafter, an example of a method for forming the multilayer electronic component 100 will be described. However, the manufacturing method of the multilayer electronic component 100 is not limited thereto.

First of all, ceramic powder for forming a dielectric layer 111 are prepared. The ceramic powder may include, for example, one or more selected from the group consisting of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), CaZrO₃, and (Ca₁₋ₓSrₓ)(Zr_{1-y}Ti_{y})O₃ (0<x≤0.5, 0<y≤0.5). BaTiO₃ powder may be synthesized, for example, by reacting a titanium raw material such as titanium dioxide with a barium raw material such as barium carbonate. A synthesizing method of the ceramic powder may include methods, for example, a solid phase method, a sol-gel method, a hydrothermal synthesis method, or the like, but the present disclosure may not be limited thereto. Next, the prepared ceramic powder are dried and ground, and then an organic solvent such as ethanol, and a binder such as polyvinyl butyral, or the like are mixed to prepare a ceramic slurry, and then the ceramic slurry is applied and dried on a carrier film to prepare a ceramic green sheet.

Next, conductive paste for an internal electrode containing metal powder, binder, organic solvent, or the like is printed onto the ceramic green sheet with a predetermined thickness using a screen printing method or a gravure printing method, thereby forming an internal electrode pattern.

Thereafter, the ceramic green sheet having the internal electrode pattern printed thereon is peeled off from the carrier film, and then the ceramic green sheet having the internal electrode pattern printed in a predetermined number of layers are stacked and pressed to form ceramic multilayer. On the upper and lower portions of the ceramic multilayer, a ceramic green sheet forming the cover portions 112 and 113 without an internal electrode pattern, may be stacked in a predetermined number of layers to form the cover portion after sintering. Thereafter, the ceramic multilayer may be cut to have a predetermined chip size, and the cut chip may be sintered at a temperature of 1000° C. or higher and 1400° C. or lower to form the body 110.

Next, the glass layer 140 may be formed. For example, a paste for forming a glass layer including first glass powder, binder, an organic solvent, or the like may be applied on the fifth and/or sixth surfaces 5 and 6 of the body 110, and then the glass layer 140 may be formed by sintering at a first temperature of 500° C. to 900° C.

Thereafter, the external electrodes 131, 132, 133, and 134 may be formed. For example, when the base electrode layers 131a, 132a, 133a, and 134a include a sintered electrode layer, a conductive paste for external electrode including metal powder, second glass powder, binder, an organic solvent, or the like may be sintered at a second temperature of 500° C. to 900° C. to form the base electrode layers 131a, 132a, 133a, and 134a. The first base electrode layers 131a and 134a may be formed by transferring the conductive paste for external electrode onto the glass layer 140 and then sintering it, and the second and third base electrode layers 132a and 133a may be formed by dipping the third and fourth surfaces 3 and 4 of the body 110 into the conductive paste for external electrode and then sintering it, however the present disclosure is not limited thereto.

In order to prevent the first glass from softening during a process of forming the base electrode layers 131a, 132a, 133a, and 134a, the first temperature may be preferably higher than the second temperature. For example, the first temperature may be higher than the softening temperature of the first glass, and the second temperature may be lower than the softening temperature of the first glass and higher than the softening temperature of the second glass.

In addition, when the base electrode layers 131a, 132a, 133a, and 134a include a resin electrode layer, a conductive resin composition including metal powder, resin, binder, and organic solvent may be applied onto the sintered electrode layer, followed by curing heat treatment at a temperature of 250° C. to 550° C. to form the resin electrode layer.

In addition, an electrolytic plating method and/or an electroless plating method may be further performed to form plating layers 131b, 132b, 133b, and 134b on the base electrode layers 131a, 132a, 133a, and 134a.

### EXAMPLE

Hereinafter, the present disclosure will be described in more detail through examples. However, the following examples are intended to help in a specific understanding of the present disclosure, and a scope of the present disclosure is not limited by the following examples.

Sample chips of Examples 1 to 7 were prepared using the above-described method for manufacturing multilayer electronic components. In the sample chip, the glass layers were respectively disposed on the fifth and sixth surfaces, and included a first glass layer and a second glass layer spaced apart from each other in the second direction. The base electrode layer was comprised of a sintered electrode layer, and the sintered electrode layer included Cu as a metal component. The plating layer is comprised of a Ni plating layer and a Sn plating layer sequentially formed on the base electrode layer. A size of the sample chip was 1005 size (length: approximately 1.0 mm, width: approximately 0.5 mm, thickness: approximately 0.5 mm).

### Example 1

In the case of Example 1, the first and second glass layers were not disposed to cover the first connection terminal. Specifically, the first and second glass layers were disposed outwardly compared to the base electrode layer. Since the first and second glass layers do not cover the first connection terminal, L2/L1 was determined to be 1.

### Examples 2 to 7

In the cases of examples 2 to 7, the first glass layer is disposed to cover one end portion of the first connection terminal in the second direction, and the second glass layer is disposed to cover the other end portion of the first connection terminal in the second direction. The cross-sections in the second and third directions, polished to the center of each sample chip in the first direction, were observed using an optical microscope or a scanning electron microscope to measure L1 and L2, and then L2/L1 values are listed in Table 1 below.

### Comparative Example

A comparative example was manufactured in the same method as the sample chip of the embodiment, except that the glass layer was not formed. Since the glass layer was not disposed on the comparative example's sample chip, L2/L1 was determined to be 1.

### The Moisture Resistance Reliability Evaluation

For each of comparative example and examples 1 to 7, 100 sample chips were mounted on a printed circuit board (PCB), and a voltage of 6.3 V was applied for 15 hours under conditions of 85° C. and 85% RH. When Insulation Resistance (IR) value decreased by more than one order or more compared to the initial IR value, the sample was evaluated as defective, and then the number of defective samples was measured and listed in Table 1 below.

### ESR Evaluation

ESR was measured by using an LCR meter (frequency: 500 kHz, SMD Fixture type probe). For each of comparative example and examples 1 to 7, ESR was measured on 10 sample chips, and then the average values are illustrated in Table 1 below.

The final evaluation was determined by considering both the moisture resistance reliability and ESR, and was evaluated as excellent (⊚), good (∘), average (Δ), and poor (X).

TABLE 1

| | | Moisture | | |
|---|---|---|---|---|
| | | Resistance | | |
| Division | L2/L1 | Reliability | ESR(mΩ) | Evaluation |
| Comparative | 1.0 | 20/100 | 10.5 | X |
| Example | | | | |
| Example 1 | 1.0 | 5/100 | 11.1 | X |
| Example 2 | 0.98 | 1/100 | 11.7 | X |
| Example 3 | 0.95 | 1/100 | 11.7 | X |
| Example 4 | 0.90 | 0/100 | 11.9 | ⊚ |
| Example 5 | 0.81 | 0/100 | 11.9 | ⊚ |
| Example 6 | 0.74 | 0/100 | 12.5 | ◯ |
| Example 7 | 0.69 | 0/100 | 13.2 | Δ |

Referring to Table 1, it may be confirmed that the moisture resistance reliability of the sample chip of Comparative Example is significantly low because the comparative example does not include the glass layer, and it may be confirmed that the moisture resistance reliability of the sample chip of Example 1 is insufficient because the glass layer is not disposed to cover the first connection terminal. In the cases of Examples 2 and 3, it can be confirmed that although the moisture resistance reliability is improved compared to the comparative example and Example 1, defects in the moisture resistance reliability still occur because L2/L1 exceeds 0.90.

However, it can be confirmed that no moisture reliability defective occurs at all in Examples 4 to 7 because L2/L1 satisfies 0.90 or less.

In the cases of Examples 4 and 5, it can be confirmed that ESR increased by only about 0.2 mΩ compared to Examples 2 and 3, while no defects in moisture reliability failure occurred. In the case of Example 6, the ESR increased by about 0.8 mΩ compared to Examples 2 and 3, but no defect in moisture reliability occurred, and thus it is evaluated that there is still a practical advantage compared to Examples 1 to 3.

In the case of Example 7, the moisture resistance reliability was improved, but the ESR increased by about 1.5 mΩ compared to Examples 2 and 3, and thus the electrical characteristics of the sample chip were determined to be significantly deteriorated.

That is, when 0.74≤L2/L1≤0.90 is satisfied, it can be confirmed that a multilayer electronic component having excellent moisture resistance reliability and excellent electrical characteristics can be provided.

The present disclosure is not limit the above-described embodiments and the accompanying drawings but is defined by the appended claims. Therefore, those of ordinary skill in the art may make various replacements, modifications, or changes without departing from the scope of the present disclosure defined by the appended claims, and these replacements, modifications, or changes should be construed as being included in the scope of the present disclosure.

In addition, the expression ‘an example embodiment’ does not mean the same embodiment, and is provided to emphasize and explain different unique characteristics. However, the embodiments presented above do not preclude being implemented in combination with the features of another embodiment. For example, although items described in a specific embodiment are not described in another embodiment, the items may be understood as a description related to another embodiment unless a description opposite or contradictory to the items is in another embodiment.

In the present disclosure, the term “connected” includes not only direct connection but also indirect connection through an adhesive layer or the like. Additionally, the term electrically connected includes both physically connected and not physically connected. In addition, the terms “first,” “second,” and the like may be used to distinguish one element from another, and may not limit a sequence and/or an importance, or others, in relation to the elements. In some cases, a first element may be referred to as a second element, and similarly, a second element may be referred to as a first element without departing from the scope of right of the example embodiments.

While the embodiments have been illustrated and described above, it will be configured as apparent to those skilled in the art that modifications and variations could be made without departing from the scope of the present disclosure as defined by the appended claims.

1. A multilayer electronic component comprising:
a body including a dielectric layer and first and second internal electrodes alternately disposed in a first direction with the dielectric layer interposed therebetween, and including first and second surfaces opposing each other in the first direction, third and fourth surfaces connected to the first and second surfaces and opposing each other in a second direction, and fifth and sixth surfaces connected to the first to fourth surfaces and opposing each other in a third direction;
a glass layer disposed on at least one surface of the fifth surface or sixth surface;
a first external electrode disposed on the glass layer and connected to the first internal electrode; and
second and third external electrodes disposed on the third and fourth surfaces, respectively, and connected to the second internal electrode;
wherein the first internal electrode has a connection terminal extending to the fifth or sixth surface,
wherein the glass layer is disposed to cover a portion of the connection terminal,
When a length of the connection terminal in the second direction is L1, and a length of a region of the connection terminal in contact with the first external electrode in the second direction is L2,
$$L 1 and L 2 satisfy 0.74 \leq L 2 / L 1 \leq 0.90 .$$

2. The multilayer electronic component of claim 1, wherein L1 and L2 satisfy L2/L1≥0.81.

3. The multilayer electronic component of claim 1, wherein the glass layer includes a first glass layer disposed to cover one end portion of the connection terminal in the second direction, and a second glass layer spaced apart from the first glass layer and disposed to cover the other end portion of the connection terminal in the second direction.

4. The multilayer electronic component of claim 3, wherein the first glass layer is disposed to extend from at least one of the fifth and sixth surfaces onto a portion of the first and second surfaces,
wherein the second glass layer is disposed to extend from at least one of the fifth and sixth surfaces onto a portion of the first and second surfaces.

5. The multilayer electronic component of claim 1, wherein a cross section of the multilayer electronic component in the second and third direction, a length of a region of the glass layer not contacting the connection terminal is greater than a length of a remaining region of the glass layer contacting the connection terminal.

6. The multilayer electronic component of claim 1, wherein the first external electrode is disposed to completely cover the glass layer.

7. The multilayer electronic component of claim 1, wherein the first external electrode includes a base electrode layer in contact with the connection terminal and a plating layer disposed on the base electrode layer.

8. The multilayer electronic component of claim 7, wherein one end portion of the glass layer in the second direction is exposed from the base electrode layer,
Wherein the plating layer is disposed to cover the one end portion of the glass layer in the second direction.

9. The multilayer electronic component of claim 7, wherein the one end portion of the glass layer in the second direction is exposed from the plating layer.

10. The multilayer electronic component of claim 1, wherein the glass layer includes a first glass including one or more selected from the group consisting of Ba, Si, Zn, Ca, Al and Mg.

11. The multilayer electronic component of claim 10, wherein the first external electrode includes a base electrode layer being in contact with the connection terminal and including a metal and a second glass,
when a sum of number of moles of Ba and Si with respect to a total number of moles of remaining elements excluding oxygen among elements configuring the first glass is M1, and a sum of number of moles of Ba and Si with respect to a total number of moles of remaining elements excluding oxygen among elements configuring the second glass is M2,
M1>M2 is satisfied.

12. The multilayer electronic component of claim 1, wherein a thickness of the glass layer is smaller than a thickness of the first external electrode.

13. The multilayer electronic component of claim 1, wherein the glass layer is disposed spaced apart from the second and third external electrodes.

14. The multilayer electronic component of claim 1, wherein a maximum length of the first external electrode in the second direction is greater than L1.

15. The multilayer electronic component of claim 1, wherein the first internal electrode includes a main portion overlapped with the second internal electrode in the first direction and a lead portion extended from the main portion to the fifth or sixth surface,
Wherein the lead portion is not overlapped with the second internal electrode in the first direction and having the connection terminal.

16. The multilayer electronic component of claim 15, wherein a maximum length of the main portion in the second direction is greater than L1.
